(19) United States
(12) Patent Application Publication
(10) Pub. No.: US 2026/0236282 A1
(43) Pub. Date: Aug. 13, 2026

(54) Systems and Methods for Executing Voice Commands to Reduce Carbon Footprint

(71) Applicant: Nanumasa Manoj Devender Goud, Hyderabad, Telengana (IN)

(72) Inventor: Nanumasa Manoj Devender Goud, Hyderabad, Telengana (IN)

(21) Appl. No.: 19/474,711

(22) PCT Filed: Apr. 8, 2024
(86) PCT No.: PCT/IN2024/050366

§ 371 Date: Oct. 11, 2025

(30) Foreign Application Priority Data
Apr. 11, 2023 (IN) 202341026729

(51) Int. Cl. G06F 9/451; G06Q 30/018; G10L 15/18; G10L 15/22

(52) U.S. Cl. CPC G06F 9/453; G06Q 30/018; G10L 15/1822; G10L 15/22; G10L 2015/223

(57) ABSTRACT

Embodiments herein relate to a voice assistant system and method for executing one or more voice commands with reduced carbon footprint. The voice assistant system and method configured for determining intent from one or more voice commands received by a user. The method includes determining one or more actions to be performed based on a carbon footprint value assigned for each item or device or component or action. The method discloses assigning individual scores for one or more actions to be performed based on a recommender, where the recommender suggests a plurality of items with lower carbon footprint values and a plurality of user preferences.

### TECHNICAL FIELD

Embodiments disclosed herein relate to voice assistant systems, and more particularly to executing one or more voice commands with reduced carbon footprint.

### BACKGROUND

Currently, intelligent voice interface systems are widely used for multiple voice assisting and controlling services; for example, food ordering services, online shopping services, vehicle voice control services, home automation services, home energy management services, travel assisting services and so on. The voice interface systems comprise voice assistants for detecting voice commands from users, performing actions for executing the voice commands, and assisting the users in completing the voice commands.

For example, in a food ordering service, if a voice command given by a user is “can i get a veg sandwich?”, then the voice assistant in the food ordering service can order a veg sandwich from a nearby restaurant. In case, if the user specifies a particular item(s) with a particular place in the voice command, for example, “can I get a veggie paradise pizza and Pepsi 500 ml from dominos”, then the voice assistant can place the order directly from dominos for the user specified item(s).

In another example, in a car voice control, if a voice command given by the user is “Drive to Pizza”, then the voice assistant in the car voice control can show a list of available options and navigate the user to a pizza place. However, arbitrarily displaying a list of pizza places or just ranking them based on location or user ratings etc., might not be relevant to the user and may not be appropriate particularly in terms of providing environmentally friendly outcomes with an enhanced user experience.

However, arbitrarily selecting an item or place or executing a particular action specified in the voice command may not be appropriate particularly in terms of providing environmentally friendly outcomes with an enhanced user experience. In some scenarios, the voice assistant can likely execute actions or place orders from the most ordered or best providers or from the most frequent actions performed. However, selection of most ordered or best providers or execution of most frequent actions may not be appropriate, if there is a best action (For example, controlling a home device, selection of a particular item) with less carbon footprint is present for a specific voice command.

### Objects

The principal object of embodiments herein is to disclose systems and methods for executing one or more voice commands with reduced carbon footprint.

Another object of embodiments herein is to disclose systems and methods for determining intent from one or more voice commands received by a user.

Another object of embodiments herein is to disclose systems and methods for determining one or more actions to be performed based on a carbon footprint value assigned for each item or device or component or action.

Another object of embodiments herein is to disclose systems and methods for assigning individual scores for one or more actions to be performed based on a recommender, where the recommender suggests a plurality of items with lower carbon footprint values and a plurality of user preferences.

### SUMMARY

Accordingly, the embodiments herein provide a voice assistant system for executing at least one voice command to reduce carbon footprint. The voice assistant system comprises an intent parser and a processor. The intent parser can be configured for deriving intent of the voice command received from at least one user. The processor can be configured to determine at least one action to be performed based on the derived intent, determine a plurality of items with corresponding carbon footprint values relevant to the determined action, and generate at least one recommended action for at least one item with a lower carbon footprint value from the plurality of items.

Accordingly, the embodiments herein provide a method for executing at least one voice command using the voice assistant system to reduce carbon footprint. The method includes receiving the voice command from at least one user, deriving an intent of the voice command, determining at least one action to be performed based on the derived intent, determining a plurality of items with corresponding carbon footprint values relevant to the determined action, and generating at least one recommended action for at least one item with a lower carbon footprint value from the plurality of items.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 depicts a voice assistant system for executing one or more voice commands, according to embodiments as disclosed herein;

FIG. 2 depicts an example flowchart for executing one or more voice commands, according to embodiments as disclosed herein;

FIG. 3 depicts a method for executing at least one voice command using the voice assistant system, according to embodiments as disclosed herein;

FIG. 4 depicts an example use case of ordering a burger, according to embodiments as disclosed herein;

FIG. 5 depicts an example use case of booking a taxi, according to embodiments as disclosed herein; and

FIG. 6 depicts an example use case of booking a flight, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

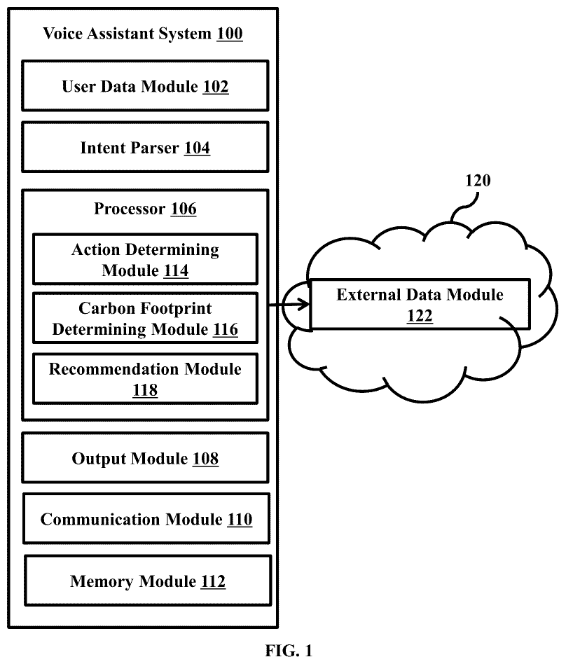

The embodiments herein achieve a system and method for executing one or more voice commands with reduced carbon footprint. Referring now to the drawings, and more particularly to FIGS. 1 through 6, where similar reference characters denote corresponding features consistently throughout the figures, there are shown embodiments.

FIG. 1 depicts a voice assistant system 100 for executing one or more voice commands received from a user. The voice assistant system 100 comprises a user data module 102, an intent parser 104, a processor 106, an output module 108, a communication module 110, and a memory module 112.

In an embodiment herein, the user data module 102 can comprise at least one user data entered by at least one user. The user data can be, but not limited to, a current location, availability of devices such as smart devices, home devices and so on, a plurality of preferences such as food, products, devices, recipes, restaurants, user experience and metrics, dietary preferences, previous order history, favorites, other user demographics, and so on.

In an embodiment herein, the intent parser 104 can derive an intent of the voice command received from the user. The intent can be derived using speech-to-text and intent classification. In an embodiment herein, in the speech-to-text classification, the user's speech can be first converted into text. There are many speech-to-text Application Programming Interfaces (APIs) available that can be used for speech conversion. In an embodiment herein, in the intent classification, multiple machine learning algorithms can be used to classify the obtained text version of the user's speech into different intents. The intent classification can be done using various approaches, such as training a supervised classifier using a pre-trained model such as Bidirectional Encoder Representations from Transformers (BERT) or OpenAI's Generative Pre-trained Transformer (GPT), or even using rule-based methods etc. to classify the text into predefined intents.

The voice command can be, for example, “can i get a veg sandwich?”, “can i book a ticket?”, “change a device operation”, “drive to some place”, “book a taxi”, “make it cooler” and so on. The derived intent of the voice command can be, but not limited to, ordering food, booking a ticket, controlling a smart device or an appliance, online order on e-commerce platforms, booking taxi and so on.

In an embodiment herein, the processor 106 can be configured to perform at least one action based on the derived intent. The processor 106 comprises an action determining module 114, a carbon footprint determining module 116, and a recommendation module 118.

The action determining module 114 can determine the action to be performed based on the derived intent. The action can be determined by mapping between intents and actions. The mapped content can be stored in a database or a configuration file for defining what action should be taken for each intent. The mapped content can be look up tables or if-else conditions and more complex rule based configurations. For example, if the user uttered “order a pizza” and the intent is determined as “placing a food order” and the extracted information is “pizza”, the lookup table would specify that the action to be executed is to order a food item with name pizza from available sources (like food delivery applications). The action can be, for example, to accomplish at least one voice command requested by the user. The action can be, for example, placing a food order, booking a bus ticket or air ticket, changing a temperature of air conditioner, online order on e-commerce platforms, booking taxi and so on.

The carbon footprint determining module 116 can determine a plurality of items with corresponding carbon footprint values relevant to the determined action. For example, if the user chooses either green or sustainable or eco mode and utters “order a pizza”, then the determined action to be order a food item with name pizza. The carbon footprint determining module can use APIs to access data from external service with a search key as “pizza” along with other user data. The external service can provide a list of available pizzas from various stores or locations along with ingredient information, recipe, nutritional information and carbon footprint for each product. The most relevant items can be determined using the recommendation module based on the available metadata. Therefore, the relevant items can be determined from data provided by external service providers, user data based on stored information and communication between the voice assistant system 100 and the external service providers. In another example, if the user has a preference to book electric vehicles or environmentally friendly products and utters “book a taxi from X to Y”, then the determined action is to book a taxi from location X to location Y. The carbon foot determining module can determine carbon footprint for all ride options based on available taxi options provided by a taxi service. For example, an electric or hybrid fleet of taxis may have a lower carbon footprint per ride than other regular options.

The items can comprise, but not limited to, products, recipes, restaurants, vehicles, smart devices, online booking services and so on. The carbon footprint determining module 116 can receive the data from external sources or publicly available data sets based on the derived intent for determining the items with corresponding carbon footprint values. The external data can be obtained from service providers or a cloud server 120.

The cloud server 120 can comprise an external data module 122 for storing a plurality of items and their corresponding carbon footprint values. The carbon footprint determining module 116 of the processor 106 can communicate with the external data module 122, through the communication module 110, for accessing the stored items with carbon footprint values.

The recommendation module 118 can generate at least one recommended action for items or combinations of items with a lower carbon footprint value. The recommendation module 118 can be a sustainable recommender which is designed to reduce carbon footprint and aid users to make sustainable choices. The recommendation module 118 can be implemented with a user selective option such as selection of a sustainable mode. The sustainable mode indicates a green option which enables for less carbon footprint value. If the user selects the sustainable mode, then a sustainable recommender can be enabled. The sustainable recommender can recommend items with lower carbon footprint values. If the user does not opt for the sustainable mode, then a normal recommender can be enabled or a prompt can be generated to set the sustainable mode.

The recommendation module 118 can combine content based approaches and collaborative filtering approaches. The recommendation module 118 can generate the recommended action using a hybrid recommender system. The hybrid recommender system combines a plurality of content based approaches and a plurality of collaborative filtering approaches. In an embodiment herein, the recommendation module 118 utilizes Artificial Intelligence (AI) to generate the recommended actions. In an embodiment herein, the recommendation module 118 can create new features that represent the carbon footprint of different items, such as the emissions per mile for a car or the energy consumption per square foot for a building or carbon footprint per unit of product, or per unit of usage using feature engineering techniques. The recommendation module 118 can apply a similarity matrix by calculating similarity between items using a similarity metric such as cosine similarity or Pearson correlation, based on their carbon footprint values and other features such as user data. The recommendation module 118 can assign at least one score to each generated recommended action with the lower carbon footprint value. Further, the recommendation module 118 can provide an output of a plurality of generated recommended actions in a list, though the output module 108, based on the assigned scores to enable selection of at least one recommended action from the provided list by the user. In an embodiment herein, the output module 108 can display or provide a voice output of the list on a user interface of an external device. The external device can be a portable electronic device such as a smart phone, a voice assistant device, a computing device and so on. The processor 106 can execute the selected recommended action selected by the user to perform the action. This reduces the carbon footprint and improves user experience.

In an embodiment herein, the processor 106 can be configured to process and execute data of plurality of modules of the voice assistant system 100. The processor 106 may comprise one or more of microprocessors, circuits, and other hardware configured for processing. The processor 106 can be configured to execute instructions stored in the memory module 112. The processor 106 can be at least one of a single processor, a plurality of processors, multiple homogeneous or heterogeneous cores, multiple Central Processing Units (CPUs) of different kinds, microcontrollers, special media, and other accelerators. The processor 106 may be an application processor (AP), a graphics-only processing unit such as a graphics processing unit (GPU), a visual processing unit (VPU), and/or an Artificial Intelligence (AI)-dedicated processor such as a neural processing unit (NPU).

In an embodiment herein, the memory module 112 can store data such as user input data and the executed output data.

In an embodiment herein, the memory module 112 may comprise one or more volatile and non-volatile memory components which are capable of storing data and instructions of the modules of the voice assistant system 100 to be executed. Examples of the memory module 112 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 112 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 112 may, in some examples, be considered a non-transitory storage medium. The term “non-transitory” may indicate that the storage medium is not embodied in a carrier wave or a propagated signal. However, the term “non-transitory” should not be interpreted to mean that the memory module 112 is non-movable. In certain examples, a non-transitory storage medium may store data that can, over time, change (e.g., in Random Access Memory (RAM) or cache).

In an embodiment herein, the plurality of modules of the processor 106 can communicate with the cloud server 120 via the communication module 110. The communication module 110 through which the modules of the processor 106 and the cloud server 120 communicate may be in the form of either a wired network or a wireless network, or a combination thereof. The wired and wireless communication networks may comprise but not limited to, GPS, GSM, LAN, Wi-Fi compatibility, Bluetooth low energy as well as NFC. The wireless communication may further comprise one or more of Bluetooth, ZigBee, a short-range wireless communication such as UWB, a medium-range wireless communication such as Wi-Fi or a long-range wireless communication such as 3G/4G/5G/6G or WiMAX, according to the usage environment.

FIG. 1 shows example modules of the voice assistant system 100, but it is to be understood that other embodiments are not limited thereon. In other embodiments, the voice assistant system 100 may include less or more number of modules. Further, the labels or names of the modules are used only for illustrative purposes and does not limit the scope of the invention. One or more modules can be combined together to perform the same or substantially similar function in the voice assistant system 100.

The voice assistant system 100 can be applicable in various voice interfacing devices and systems such as home automation, food ordering systems, online shopping systems and services, kiosks, vehicles, drive-ins, drive-thrus and so on.

For example, if a voice command given by a user is “order a chicken burger”, then the processor 106 can recommend restaurants which serve chicken burgers using a recipe with a lower carbon footprint. The processor 106 can process the voice command based on a user diet preference for choosing planet friendly meals. Such diet preferences can be vegan, plant-based, climatarian, sustainable, dairy free and so on.

The voice assistant system 100 can be trained with a plurality of use cases to reduce the carbon footprint for each case. The use cases of the voice assistant system 100 can be home automation with energy management, transportation with taxi or flight bookings, and online orders such as food, clothing, electronics or other e-commerce products.

For example, in home automation use case, information from various applications can be used to identify the emissions associated with the energy usage:
Energy consumption: Information about the energy consumption of a plurality of devices and systems in the home, such as smart thermostats, lights, appliances, and HVAC systems.
Energy efficiency: Information about the energy efficiency of the devices and systems, such as their energy star rating.
Smart controls: Information about the availability and usage of smart controls, such as smart thermostats.
Renewable energy: Information about the renewable energy sources, such as solar or wind power.
Building materials: Information about the materials used in the construction of home.
Insulation: Information about the insulation of the home.
Temperature: The temperature settings of the home.
Occupancy: Information about the occupancy of the home.
Location: Information about the location of the home with weather and climate conditions of the area.

For example, in transportation bookings use case, information from various applications can be used to identify the emissions associated with the transportation:
Distance traveled: The distance between pick-up and drop-off location for a taxi, or the distance between departure and arrival airports for a flight.
Type of transportation: The type of transportation used, such as car, train, or airplane.
Fuel efficiency: Information about the fuel efficiency of vehicles.
Alternative options: Information about alternative options for transportation, such as carpooling, biking or walking.
Time of travel: The time of travel with traffic and weather conditions.
Popularity: Popularity of the transportation with a plurality of popular options and recommendations accordingly.
Price: The price of the transportation with a plurality of affordable options and recommendations accordingly.
Carbon offset: Information about carbon offset programs can help to identify the options that have been offset by carbon credits which can in turn help to identify a plurality of sustainable options and make recommendations accordingly.
Airline/taxi company: Information about the airline or taxi company, can help to identify a plurality of sustainable options and make recommendations accordingly. For airlines, a radiative forcing factor or other factors can be considered which would indicate the emissions at higher altitudes.

For example, in online food ordering use case:
Item origin: The location where the items were produced or manufactured can help to identify the distance of the item needs to travel, and the associated transportation emissions.
Farming practices: Information about the farming practices used to produce the ingredients, such as organic, sustainable, or conventional farming, can help to identify the emissions associated with the production of the food.
Type of food or item: The category of food, such as meat, dairy, plant-based, and son on, can help to identify the emissions associated with the production of different types of food.
Packaging materials: The type of packaging materials used, such as plastic, paper, or biodegradable materials, can help to identify the emissions associated with the packaging of items.
Seasonality: Information about the seasonality of the ingredients can help to identify the emissions associated with the transportation of the food, as locally sourced ingredients may have lower transportation emissions.
Energy usage: Information about the energy usage during the production, packaging, and transportation of the food or items, can help to identify the emissions associated with these processes.
Nutritional value: Nutritional value of the food, this can help to identify the healthier options and make recommendations accordingly.
Popularity: Popularity of the food or item can help to identify a plurality of popular options and make recommendations accordingly.
Price: The price of the food or item can help to identify a plurality of affordable options and make recommendations accordingly.

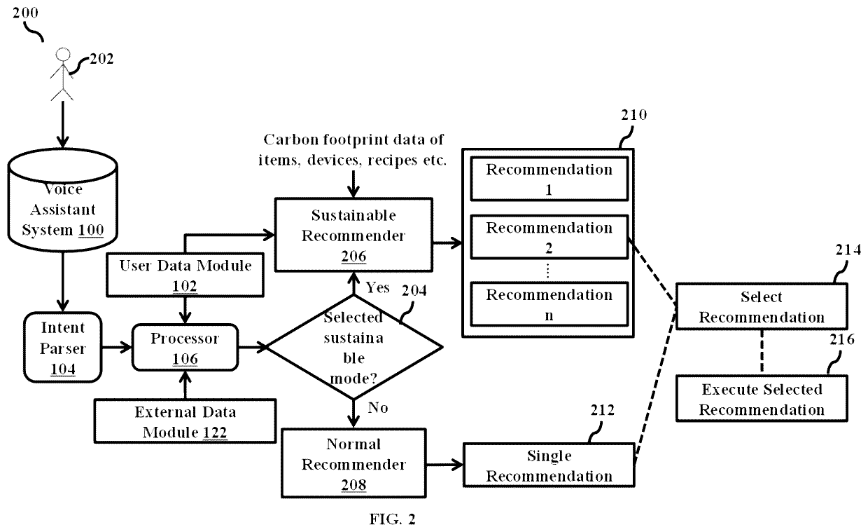

FIG. 2 depicts an example flowchart 200 for executing one or more voice commands. When a user 202 gives a voice command, the intent parser 104 receives the voice command and derives the intent of the voice command such as to order food or to control a home device. The intent of the voice command is processed by the processor 106 by verifying the user data from the user data module 102 and the external data from the external data module 122.

For example, if a food order is given as a voice command, then the external data which can be obtained from service providers or the cloud server 120 can comprise, but not limited to, place and menu providers, catalogue providers, online catalogue of items of the ordered food, menu and timings of the store, whether the store can deliver the order to your location or not and so on, based on user preferences and customizations obtained from the user data.

The processor 106 determines the action to be performed based on the derived intent, determines at least one item with a corresponding carbon footprint value relevant to the determined action, and generates at least one recommended action for the item with a lower carbon footprint value.

In an embodiment herein, the processor 106 verifies whether the user has selected a sustainable mode, as depicted at step 204. If the user selects the sustainable mode, then a sustainable recommender 206 is selected by the recommendation module 118. The sustainable recommender 206 provides a plurality of recommendations, as depicted at 210, such as recommendation 1, recommendation 2 . . . recommendation n with items having lower carbon footprint values. The sustainable recommender 206 obtains item details such as carbon footprint data, the way item is produced and so on, from the external data module 122. If the user has not selected the sustainable mode, then a normal recommender 208 is selected by the recommendation module 118. The normal recommender 208 provides a single recommendation 212. Further, the user 202 selects at least one recommendation, as depicted at 214. Further, the processor 106 executes the user selected recommendation, as depicted at step 216.

For example, generally orders are associated with a delivery. If the user 202 selects a sustainable delivery, then the voice assistant system 100 can provide the carbon footprint value for delivery. Thus, the user 202 can decide whether the order needs to be delivered at his/her location or to directly pick up from a point.

Therefore, any user command given to a voice assistant system 100 can have a resulting footprint in terms of execution, order processing or command execution in the home automation or booking a cab or taxi and so on.

In an embodiment herein, a prompt can be generated and displayed, by the voice assistant system 100, to the user to select the sustainable mode if user has not provided any preferences for less carbon emissions or Greenhouse Gases (GHG) emissions.

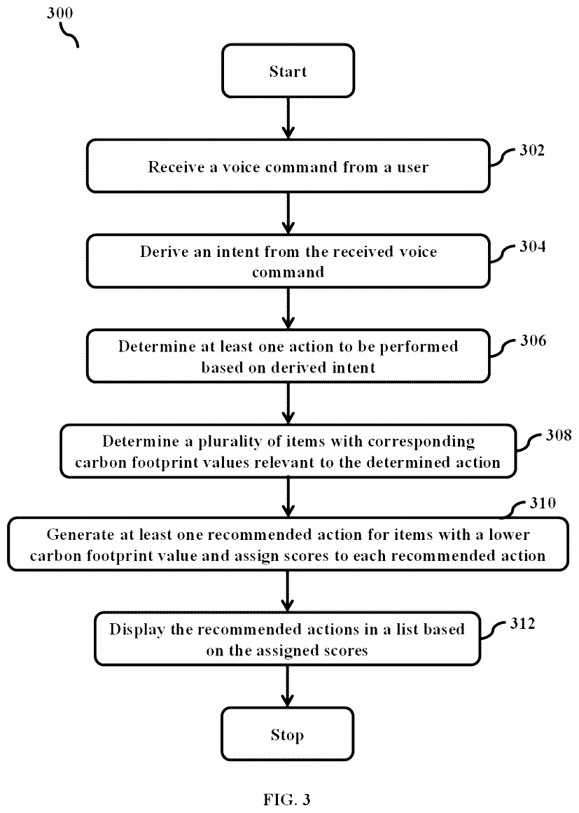

FIG. 3 depicts a method 300 for executing at least one voice command using the voice assistant system 100 to reduce carbon footprint. The method 300 discloses receiving, by the intent parser 104, a voice command from a user, as depicted at step 302. The method 300 discloses deriving, by the intent parser 104, intent from the received voice command, as depicted at step 304. Thereafter, the method 300 discloses determining, by the action determining module 114 of the processor 106, at least one action to be performed based on the derived intent, as depicted in step 306.

Later, the method 300 includes determining, by the carbon footprint determining module 116 of the processor 106, a plurality of items with corresponding carbon footprint values relevant to the determined action, as depicted in step 308. The method 300 includes generating, by the recommendation module 118 of the processor 106, at least one recommended action for at least one item with a lower carbon footprint value from the plurality of items and assigning scores to the generated recommended action, as depicted in step 310. The method 300 includes displaying or providing a voice based output of the recommended actions in a list to the user based on the assigned scores, as depicted in step 312.

The various actions in method 300 may be performed in the order presented, in a different order or simultaneously. Further, in some embodiments, some actions listed in FIG. 3 may be omitted.

In a use case of food items, table 1 depicts equivalent CO2 emissions for different burgers.

TABLE 1

| Items | Pounds of CO2e emissions |
|---|---|
| Beyond Burger | 3.5 |
| Impossible Burger | 3.1 |
| Black Bean Burger | 0.9 |
| Quorn Meatless Ultimate Burger | 6.1 |
| Turkey Burger | 3.3 |
| Lamb Burger | 5.9 |

For example, the veggies burgers such as beyond burger, impossible burger, and black bean burger comprise the equivalent CO2 emissions as given below:

Beyond Burger: The beyond burger is a popular plant-based burger made with pea protein, coconut oil, and other ingredients. According to the company, producing one beyond burger generates 3.5 pounds of CO2e emissions.

Impossible Burger: The impossible burger is another popular plant-based burger that is made with soy protein and other ingredients. According to a life cycle analysis conducted, producing one impossible burger generates 3.1 pounds of CO2e emissions.

Black Bean Burger: A homemade black bean burger is a delicious and sustainable option. The CO2e value depends on the ingredients and production methods used, but it is generally lower than commercial alternatives. On average, a black bean burger produces around 0.9 pounds of CO2e emissions.

Another example of a veggie burger with a higher CO2e value is a quorn meatless ultimate burger. According to the Quorn website, producing one of these burgers generates 6.1 pounds of CO2e emissions, since this burger is made from mycoprotein which requires energy-intensive fermentation processes. While Quorn is a plant-based protein, its high CO2e value is due to the production methods used to create it.

The meat based burgers such as beef burger, turkey burger, and lamb burger comprise the equivalent CO2 emissions as given below:

Beef Burger: A beef burger is a classic burger made from ground beef. The CO2e value of a beef burger can vary depending on several factors, such as the production method, feed, and transportation. However, on average, producing a quarter-pound beef burger generates around 6.6 pounds of CO2e emissions.

Turkey Burger: A turkey burger is a leaner alternative to a beef burger, made from ground turkey. The CO2e value of the turkey burger is generally lower than a beef burger, as turkey production generates fewer emissions than beef. On average, producing a quarter-pound turkey burger generates around 3.3 pounds of CO2e emissions.

Lamb Burger: A lamb burger is made from ground lamb meat and has a distinct flavor. The CO2e value of the lamb burger is higher than the turkey burger but lower than the beef burger. On average, producing a quarter-pound lamb burger generates around 5.9 pounds of CO2e emissions. However, like beef burgers, the CO2e value of lamb burgers can vary depending on several factors.

In a use case of food recipes, table 2 depicts equivalent CO2 emissions for different recipes.

TABLE 2

| | | kg CO2 emissions |
|---|---|---|
| Items | Recipes | per serving |
| Spaghetti with | Vegan recipe | 2.2 |
| tomato sauce | | |
| Spaghetti with tomato | Recipe | 5.5 |
| sauce (beef) | with beef | |
| Stir-fry | Vegan recipe | 1.0 |
| Stir-fry | Chicken | 2.5 |

For example, the below recipes comprise the equivalent CO2 emissions.
Spaghetti with tomato sauce:
Vegan recipe: About 2.5 kg CO2e emissions per serving,
Recipe with beef: About 5.5 kg CO2e emissions per serving,
Burger:
Vegan recipe: About 1.5 kg CO2e emissions per serving,
Recipe with beef: About 5.5 kg CO2e emissions per serving,
Stir-fry:
Vegan recipe: About 1.0 kg CO2e emissions per serving,
Recipe with chicken: About 2.5 kg CO2e emissions per serving,

The equivalent values are approximate and may vary depending on several factors, such as the ingredients used, the production and transportation methods for those ingredients, and the cooking methods employed. The values provided are based on estimates from various sources, such as academic studies and environmental organizations. Additionally, the values do not take into account other environmental impacts associated with food production and consumption, such as water use and land use.

For example, for spaghetti and meatballs:
Beef meatballs with tomato sauce: 6.9 kg CO2e per kg of food
Vegetarian meatballs with tomato sauce: 2.9 kg CO2e per kg of food
Grilled Cheese Sandwich:
Classic grilled cheese made with processed cheese and white bread: 2.2 kg CO2e per kg of food,
Grilled cheese made with artisanal cheese and sourdough bread: 3.3 kg CO2e per kg of food,
Pizza:
Pizza with meat toppings: 9.9 kg CO2e per kg of food,
Pizza with vegetable toppings: 7.2 kg CO2e per kg of food.

The equivalent values are approximate and may vary depending on several factors, such as the specific ingredients used and the energy efficiency of the cooking equipment. Additionally, the values do not take into account the embodied emissions associated with the production, transportation, and disposal of the food ingredients.

For example, table 3 depicts summarized CO2 emissions for different vehicles.

In a use case of vehicles, table 3 depicts equivalent CO2 emissions for different vehicles.

TABLE 3

| Vehicles | Pounds of CO2 emissions |
|---|---|
| Traditional gasoline- | 4.5 |
| powered taxi | |
| Hybrid taxi | 2.9 |
| Electric taxi | 2.7 |

For example, the below vehicles comprise the equivalent CO2 emissions.
Taxi Booking based on vehicle type:
Traditional gasoline-powered taxi: On average, a traditional gasoline-powered taxi generates around 0.45 pounds of CO2e emissions per mile traveled. So, for a 10-mile ride, the approximate CO2e emissions may be 4.5 pounds.
Hybrid taxi: A hybrid taxi, which uses a combination of gasoline and electricity, generates lower emissions than a traditional gasoline-powered taxi. On average, a hybrid taxi generates around 0.29 pounds of CO2e emissions per mile traveled. So, for a 10-mile ride, the approximate CO2e emissions may be 2.9 pounds.
Electric taxi: An electric taxi generates no direct emissions, as it runs entirely on electricity. However, the indirect emissions associated with the electricity generation must be taken into account. The average CO2e emissions associated with the electricity generation is around 0.95 pounds per kWh. Assuming the electric taxi travels 10 miles and has an efficiency of 3.5 miles per kWh, the approximate CO2e emissions would be around 2.7 pounds.

The equivalent values are approximate and may vary depending on several factors, such as the vehicle's make and model, driving conditions, and passenger load.

In a use case of light bulbs, table 4 depicts equivalent CO2 emissions for different light bulbs.

TABLE 4

| | Source of | Pounds of CO2 emissions |
|---|---|---|
| Devices | electricity | per hour of use |
| Incandescent | Coal | 1.5 |
| light bulb | | |
| | Natural gas | 1.1 |
| | Wind | 0.2 |
| Compact fluorescent | Coal | 0.4 |
| light bulb (CFL) | | |
| | Natural gas | 0.3 |
| | Wind | 0.05 |
| LED light bulb | Coal | 0.3 |
| | Natural gas | 0.2 |
| | Wind | 0.03 |

For example, the below lighting devices based on source of electricity comprise the equivalent CO2 emissions.
Incandescent light bulb: The CO2e emissions for a 60-watt incandescent bulb vary based on the source of electricity. Here are some examples:
Coal: 1.5 pounds of CO2e emissions per hour of use,
Natural gas: 1.1 pounds of CO2e emissions per hour of use,
Wind: 0.2 pounds of CO2e emissions per hour of use,
Compact fluorescent light bulb (CFL): The CO2e emissions for a 15-watt CFL also vary based on the source of electricity. Here are some examples:
Coal: 0.4 pounds of CO2e emissions per hour of use,
Natural gas: 0.3 pounds of CO2e emissions per hour of use,
Wind: 0.05 pounds of CO2e emissions per hour of use,
LED light bulb: The CO2e emissions for a 10-watt LED bulb also vary based on the source of electricity. Here are some examples:
Coal: 0.3 pounds of CO2e emissions per hour of use,
Natural gas: 0.2 pounds of CO2e emissions per hour of use,
Wind: 0.03 pounds of CO2e emissions per hour of use,

The equivalent values are approximate and may vary depending on several factors, such as the type of fuel used to generate the electricity, the energy efficiency of the lighting device, and the region where the electricity is being generated. Additionally, these values do not take into account the embodied emissions associated with the production, transportation, and disposal of the lighting devices.

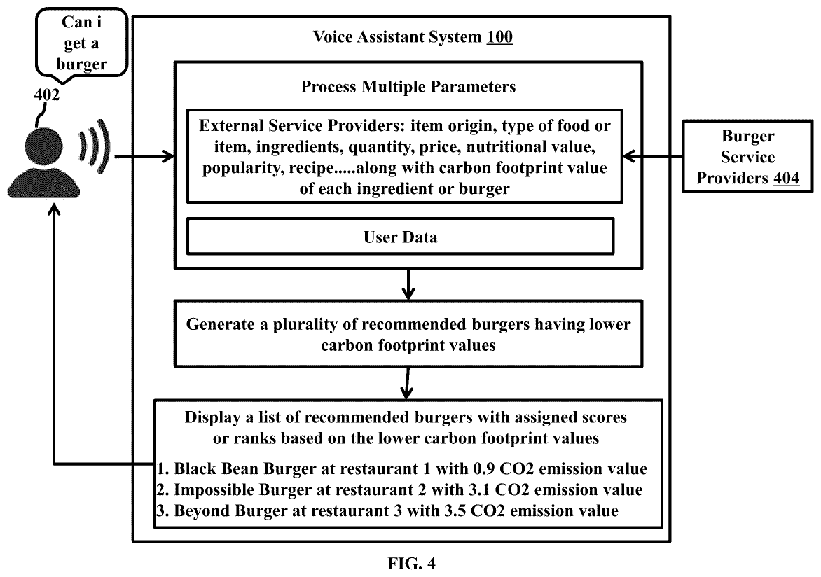

FIG. 4 depicts an example use case of ordering a burger. When a user 402 gives a voice command as “Can i get a burger” to the voice assistant system 100, the voice assistant system 100 processes the voice command by considering various parameters from various sources. The parameters include such as farming practices, item origin, type of food or item, ingredients, quantity, price, packaging materials, seasonality, energy usage, nutritional value, popularity, recipe etc., relevant to the burger along with carbon footprint values of each ingredient of each burger. The parameters also include any user data such as user preferences, diet preferences etc. The parameters can be considered from burger service providers 404 and from the user 402. The parameters and the user data are processed by the voice assistant system 100 to generate a plurality of recommended burgers having lower carbon footprint values. Later, a list of recommended burgers with assigned scores or ranks are displayed on a user interface of external device, based on the lower carbon footprint values. The list of recommended burgers displayed to be selected by the user 402. In the list, a first recommendation with rank 1 comprises a black bean burger at restaurant 1 with 0.9 CO₂ emission value, a second recommendation with rank 2 comprises an impossible burger at restaurant 2 with 3.1 CO₂ emission value, and a third recommendation with rank 3 comprises a beyond burger at restaurant 3 with 3.5 CO₂ emission value.

In an embodiment herein, if the voice assistant system 100 is configured in a car and the user pre-configured his/her preferences like vegan and/or data related to earlier order, that data can be considered by the voice assistant system 100. Based on the external data and the user data, the voice assistant system 100 configured in the car provide a better recommendation with reduced CO₂ values.

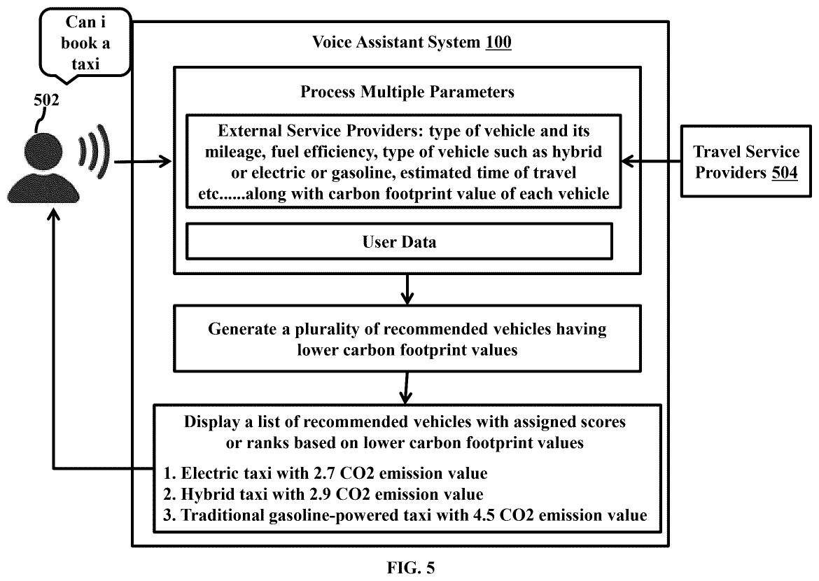

FIG. 5 depicts an example use case of booking a taxi. When a user 502 gives a voice command as “Can i book a taxi” to book a taxi to the voice assistant system 100, the voice assistant system 100 processes the voice command by considering various parameters from various sources. The voice command includes source and destination locations of travel. The parameters include such as type of vehicle and its mileage, fuel efficiency, type of vehicle such as hybrid or electric or gasoline, estimated time of travel etc., relevant to the travel details mentioned in the voice command, along with carbon footprint values of each vehicle. The parameters also include any user data such as user travel preferences. The parameters can be considered from travel service providers 504 and from the user 502. The parameters and the user data are processed by the voice assistant system 100 to generate a plurality of recommended vehicles having lower carbon footprint values. Later, a list of recommended vehicles with assigned scores or ranks are displayed on a user interface of external device, based on the lower carbon footprint values. The list of recommended vehicles displayed to be selected by the user 502. In the list, a first recommendation with rank 1 comprises an electric taxi with 2.7 CO₂ emission value, a second recommendation with rank 2 comprises a hybrid taxi with 2.9 CO₂ emission value, and a third recommendation with rank 3 comprises a traditional gasoline-powered taxi with 4.5 CO₂ emission value.

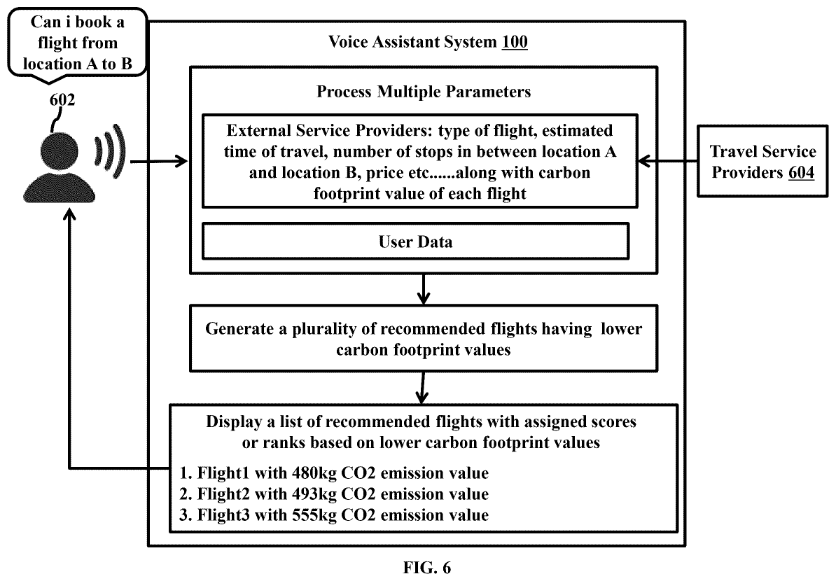

FIG. 6 depicts an example use case of booking a flight. When a user 602 gives a voice command as “Can i book a flight from location A to B” to book a flight, to the voice assistant system 100, the voice assistant system 100 processes the voice command by considering various parameters from various sources. The voice command includes source and destination locations of travel. The parameters include such as type of flight, estimated time of travel, number of stops in between location A and location B, price etc., relevant to the travel details mentioned in the voice command, along with carbon footprint values of each flight. The parameters also include any user data such as user travel preferences. The parameters can be considered from travel service providers 604 and from the user 604. The parameters and the user data are processed by the voice assistant system 100 to generate a plurality of recommended flights having lower carbon footprint values. Later, a list of recommended flights with assigned scores or ranks are displayed on a user interface of external device, based on the lower carbon footprint values. The list of recommended flights displayed to be selected by the user 602. In the list, a first recommendation with rank 1 comprises a first flight with 480 kg CO₂ emission value, a second recommendation with rank 2 comprises a second flight with 493 kg CO₂ emission value, and a third recommendation with rank 3 comprises a third flight with 555 kg CO₂ emission value.

The embodiments disclosed herein can be implemented through at least one software program running on at least one hardware device. The modules shown in FIG. 1 include blocks which can be at least one of a hardware device, or a combination of hardware device and software module.

The embodiment disclosed herein describes a voice assistant system 100 and method 300 for executing one or more voice commands with reduced carbon footprint. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

I claim:

1. A voice assistant system for executing at least one voice command, comprising:
an intent parser configured for deriving an intent of the at least one voice command received from at least one user;
a processor configured to:
determine at least one action to be performed based on the derived intent;
determine a plurality of items with corresponding carbon footprint values relevant to the determined at least one action; and
generate at least one recommended action for at least one item with a lower carbon footprint value from the plurality of items.

2. The voice assistant system as claimed in claim 1, wherein the processor is configured for receiving at least one user data and at least one external data based on the derived intent for determining the at least one item with the corresponding carbon footprint value.

3. The voice assistant system as claimed in claim 2, wherein the at least one user data comprises at least one of a current location, availability of devices, a plurality of preferences such as food, products, devices, recipes, restaurants, user experience and metrics, dietary preferences, previous order history, favorites, and other user demographics.

4. The voice assistant system as claimed in claim 2, wherein the at least one external data comprises details of the plurality of items and corresponding carbon footprint values.

5. The voice assistant system as claimed in claim 4, wherein the plurality of items comprises at least one of products, recipes, restaurants, vehicles, smart devices, and online booking services.

6. The voice assistant system as claimed in claim 1, wherein the processor is configured to:
assign at least one score to each generated recommended action with the lower carbon footprint value;
provide an output of a plurality of generated recommended actions in a list based on the assigned at least one score; and
execute the at least one recommended action selected by the at least one user from the provided list.

7. The voice assistant system as claimed in claim 1, wherein the processor generates the at least one recommended action using a hybrid recommender system, wherein the hybrid recommender system combines a plurality of content based approaches and a plurality of collaborative filtering approaches.

8. The voice assistant system as claimed in claim 1, wherein the processor utilizes Artificial Intelligence (AI) to generate the at least one recommended action.

9. A method for executing at least one voice command using a voice assistant system, comprising:
receiving, by an intent parser, the at least one voice command from at least one user;
deriving, by the intent parser, an intent of the at least one voice command;
determining, by a processor, at least one action to be performed based on the derived intent;
determining, by the processor, a plurality of items with corresponding carbon footprint values relevant to the determined at least one action; and
generating, by the processor, at least one recommended action for at least one item with a lower carbon footprint value from the plurality of items.

10. The method as claimed in claim 9, wherein the method discloses receiving at least one user data and at least one external data based on the derived intent for determining the at least one item with the corresponding carbon footprint value.

11. The method as claimed in claim 10, wherein the at least one user data comprises at least one of a current location, availability of devices, a plurality of preferences such as food, products, devices, recipes, restaurants, user experience and metrics, dietary preferences, previous order history, favorites, and other user demographics.

12. The method as claimed in claim 10, wherein the at least one external data comprises details of the plurality of items and corresponding carbon footprint values.

13. The method as claimed in claim 12, wherein the plurality of items comprises at least one of products, recipes, restaurants, vehicles, smart devices, and online booking services.

14. The method as claimed in claim 9, wherein the method discloses:
assigning, by the processor, at least one score to each generated recommended action with the lower carbon footprint value;
providing, by the processor, an output of a plurality of generated recommended actions in a list based on the assigned at least one score; and
executing, by the processor, the at least one recommended action selected by the at least one user from the provided list.

15. The method as claimed in claim 9, wherein the method discloses generating the at least one recommended action using a hybrid recommender system, wherein the hybrid recommender system combines a plurality of content based approaches and a plurality of collaborative filtering approaches.

16. The method as claimed in claim 9, wherein the method discloses generating the at least one recommended action using Artificial Intelligence (AI).
